(19) United States
(12) Patent Application Publication
(10) Pub. No.: US 2023/0101805 A1
(43) Pub. Date: Mar. 30, 2023

(54) IN-VEHICLE VIRTUAL SOUNDSCAPE METHOD, SYSTEM AND DEVICE

(71) Applicant: AAC Microtech (Changzhou) Co., Ltd., Changzhou City (CN)

(72) Inventors: Shuyuan Sun, Shenzhen (CN); Yiming Meng, Shenzhen (CN); Hao Yin, Shenzhen (CN)

(21) Appl. No.: 17/555,525

(22) Filed: Dec. 20, 2021

(30) Foreign Application Priority Data
Sep. 24, 2021 (CN) 202111122693.8

(51) Int. Cl. H04R 5/02; B60R 11/02

(52) U.S. Cl. CPC H04R 5/02; B60R 11/0217; B60R 2011/0005; H04R 2499/13

(57) ABSTRACT

The present disclosure discloses an in-vehicle virtual soundscape method, a virtual soundscape is arranged in the automobile, the virtual soundscape is a sound scenario of a target environment created acoustically in the automobile, the method comprises the following steps: S1, processing a specific program material signal by means of a preset algorithm, and generating an audio signal; and S2, playing a sound in the audio signal by means of the virtual soundscape, the specific program material signal being a multi-track dry sound recorded for real representation of an acoustic scenario of the target environment. The present disclosure further discloses an in-vehicle virtual soundscape system including a vehicle-mounted information entertainment module, a multi-channel audio link module, a processor module, an audio drive module, and a multi-channel speaker which are connected in sequence. Compared with the related art, the user experience of the technical solutions of the present invention is good.

### TECHNICAL FIELD

The present invention relates to the technical field of vehicle-mounted entertainment, in particular to an in-vehicle virtual soundscape method, an in-vehicle virtual soundscape system and an in-vehicle virtual soundscape electronic device.

### BACKGROUND

With the rapid development of automobile technology, the technological update for smart cockpits has provided users with lots of better user experiences. A vehicle-mounted sound system is an important part of the smart cockpit.

In the related art, the vehicle-mounted sound system includes vehicle-mounted entertainment device, a power amplifier, and a speaker.

However, the solutions of the related art have always focused on the performance of the power amplifier and the performance of the speaker, and no in-vehicle virtual soundscape is formed for the vehicle-mounted sound system. An in-vehicle virtual soundscape is a brand-new in-vehicle acoustic experience, which refers to using the in-vehicle sound system to create an acoustic scenario of a target environment, such as a primitive rainforest scenario, a sweetveld scenario, a vocal concert scenario, a movie theater environment scenario, and other special sound scenarios, so that it allows users to feel as if they are in the target environment even though they are in the vehicle. If the in-vehicle virtual soundscape cooperates with an in-vehicle large screen or ring screen in a future smart cockpit, the user can get a better sense of presence and immersion when watching movies in the vehicle.

Therefore, it is necessary to provide a new method, system and device to solve the above technical problems.

### SUMMARY

The present invention aims to solve the above technical problems and provides an in-vehicle virtual soundscape method, an in-vehicle virtual soundscape system, an in-vehicle virtual soundscape electronic device, and a computer-readable storage medium.

In order to achieve the above objective, in the first aspect, the embodiments of the present invention provide an in-vehicle virtual soundscape method applied to an automobile, wherein virtual soundscape is arranged in the automobile, the virtual soundscape is a sound scenario of a target environment created acoustically in the automobile. The method comprises the following steps:

S1, processing a specific program material signal by means of a preset algorithm, and generating an audio signal; and

S2, playing a sound in the audio signal by means of the virtual soundscape, the specific program material signal being a multi-track dry sound recorded for real representation of an acoustic scenario of the target environment.

Preferably, the automobile is equipped with a multi-channel speaker; the virtual soundscape is realized by the multi-channel speaker that plays a sound in the audio signal; the multi-channel speaker comprises a middle channel speaker, a left front channel speaker, a right front channel speaker, a left rear channel speaker, a right rear channel speaker, a left rear surround channel speaker, a right rear surround channel speaker, a sky channel left front speaker, a sky channel right front speaker, a sky channel left rear speaker, and a sky channel right rear speaker;

wherein, the middle channel speaker is arranged at a center position of a central control instrument panel of the automobile; the left front channel speaker is arranged on a front left door of the automobile; the right front channel speaker is arranged on a front right door of the automobile; the left rear channel speaker is arranged on a rear left door of the automobile; the right rear channel speaker is arranged on a rear right door of the automobile; the left rear surround channel speaker is arranged on a left C-pillar of the automobile; the right rear surround channel speaker is arranged on a right C-pillar of the automobile; the sky channel left front speaker is arranged above the left part of the top of a driver seat of the automobile; the sky channel right front speaker is arranged above the right part of the top of a front seat of the automobile; the sky channel left rear speaker is arranged above the left part of the top of a rear seat of the automobile; and the sky channel right rear speaker is arranged above the right part of the top of the rear seat of the automobile.

Preferably, each of the middle channel speaker, the left front channel speaker, the right front channel speaker, the left rear channel speaker, the right rear channel speaker, the left rear surround channel speaker, the right rear surround channel speaker, the sky channel left front speaker, the sky channel right front speaker, the sky channel left rear speaker, and the sky channel right rear speaker is a channel speaker composed of one speaker unit, or a channel speaker composed of a spit frequency system consisting of a plurality of speaker units.

Preferably, the sky channel left front speaker, the sky channel right front speaker, the sky channel left rear speaker, and the sky channel right rear speaker are respectively arranged at any one selected from a group consisting of a ceiling position in the automobile, a top position of an A-pillar, a top position of a B-pillar, and a top position of a C-pillar.

Preferably, in the step S1, the preset algorithm is performing convolution processing on the multi-track dry sound and an acoustic impulse response obtained in the target environment.

In the second aspect, the embodiments of the present invention further provide an in-vehicle virtual soundscape system, wherein the in-vehicle virtual soundscape system is configured for being mounted in an automobile to realize a virtual soundscape; the virtual soundscape is a sound scenario of a target environment created acoustically in the automobile; the in-vehicle virtual soundscape system comprises a vehicle-mounted information entertainment module, a multi-channel audio link module, a processor module, an audio drive module, and a multi-channel speaker which are connected in sequence;
the vehicle-mounted information entertainment module is configured for outputting a specific program material signal in a content to be played, the specific program material signal being a multi-track dry sound recorded for real representation of an acoustic scenario of the target environment;
the multi-channel audio link module is configured for transmitting the specific program material signal;
the processor module is configured for processing the received specific program material signal by means of a preset algorithm, and generating an audio signal; the preset algorithm is performing convolution processing on the multi-track dry sound and an acoustic impulse response obtained in the target environment; the acoustic impulse response is pre-stored in the processor module;
the audio drive module is configured for performing digital-to-analog conversion on the received audio signal and generating an audio drive signal;
the multi-channel speaker is configured for playing a sound in the received audio drive signal to realize the virtual soundscape.

Preferably, the multi-channel audio link module is a digital signal link or analog signal link; the digital signal link comprises an A2B audio bus and a TDM audio link; the analog signal link comprises a copper audio wiring harness and a gold audio wiring harness;

a power amplifier is further arranged in the in-vehicle virtual soundscape system; the power amplifier is configured for performing power amplification on a received electric signal; and the power amplifier is arranged in a circuit of the vehicle-mounted information entertainment module or a circuit of the audio drive module.

Preferably, the virtual soundscape is realized by the multi-channel speaker that plays a sound in the audio signal; the multi-channel speaker comprises a middle channel speaker, a left front channel speaker, a right front channel speaker, a left rear channel speaker, a right rear channel speaker, a left rear surround channel speaker, a right rear surround channel speaker, a sky channel left front speaker, a sky channel right front speaker, a sky channel left rear speaker, and a sky channel right rear speaker;
wherein the middle channel speaker is arranged at a center position of a central control instrument panel of the automobile; the left front channel speaker is arranged on a front left door of the automobile; the right front channel speaker is arranged on a front right door of the automobile; the left rear channel speaker is arranged on a rear left door of the automobile; the right rear channel speaker is arranged on a rear right door of the automobile; the left rear surround channel speaker is arranged on a left C-pillar of the automobile; the right rear surround channel speaker is arranged on a right C-pillar of the automobile; the sky channel left front speaker is arranged above the left part of the top of a driver seat of the automobile; the sky channel right front speaker is arranged above the right part of the top of a front seat of the automobile; the sky channel left rear speaker is arranged above the left part of the top of a rear seat of the automobile; the sky channel right rear speaker is arranged above the right part of the top of the rear seat of the automobile;
the sky channel left front speaker, the sky channel right front speaker, the sky channel left rear speaker, and the sky channel right rear speaker are respectively arranged at any one selected from a group consisting of a ceiling position in the automobile, a top position of an A-pillar, a top position of a B-pillar, and a top position of a C-pillar;
each of the middle channel speaker, the left front channel speaker, the right front channel speaker, the left rear channel speaker, the right rear channel speaker, the left rear surround channel speaker, the right rear surround channel speaker, the sky channel left front speaker, the sky channel right front speaker, the sky channel left rear speaker, and the sky channel right rear speaker is a channel speaker composed of one speaker unit, or a channel speaker composed of a spit frequency system consisting of a plurality of speaker units.

In the third aspect, the embodiments of the present invention further provide an in-vehicle virtual soundscape electronic device, wherein the in-vehicle virtual soundscape electronic device comprises a processor and a memory; the memory stores a computer program capable of being executed by the processor; the processor reads a program in the memory to implement the steps in any one of the above in-vehicle virtual soundscape methods.

Compared with the related art, the in-vehicle virtual soundscape method, the in-vehicle virtual soundscape system, the in-vehicle virtual soundscape electronic device, and the computer-readable storage medium can all be realized through the steps of the in-vehicle virtual soundscape method. The virtual soundscape is arranged in the automobile and is a sound scenario of the target environment created acoustically in the automobile. In particular, the in-vehicle virtual soundscape method comprises the following steps: S1, processing a specific program material signal by means of a preset algorithm, and generating an audio signal; and S2, playing a sound in the audio signal by means of the virtual soundscape, the specific program material signal being a multi-track dry sound recorded for real representation of an acoustic scenario of the target environment. In the above method, the virtual soundscape is arranged in the automobile, and the recorded multi-track dry sound is made into the audio signal, so that the sound in the audio signal is played by means of the virtual soundscape to really represent the acoustic scenario of the target environment. Users can experience auditory perception in the automobile as if they were in the target environment and can get a better sense of presence and immersion, so that the user experience is good.

### BRIEF DESCRIPTION OF THE DRAWINGS

In order to explain the technical solutions of the embodiments of the present invention more clearly, the following will briefly introduce the accompanying drawings used in the description of the embodiments. Apparently, the drawings in the following description are only some embodiments of the present invention. Those of ordinary skill in the art can obtain other drawings based on these drawings without creative work.

FIG. 1 is a flowchart of an in-vehicle virtual soundscape method according to the embodiments of the present invention;

FIG. 2 is a schematic diagram of The first example of an in-vehicle virtual soundscape method of the present invention;

FIG. 3 is a schematic diagram of The first example of an in-vehicle virtual soundscape method of the present invention from another view;

FIG. 4 is an oscillograph of a specific program material signal of an in-vehicle virtual soundscape method of the present invention;

FIG. 5 is a structural block diagram of an in-vehicle virtual soundscape system according to the embodiments of the present invention; and

FIG. 6 is a schematic structural diagram of an in-vehicle virtual soundscape electronic device according to the embodiments of the present invention.

### DETAILED DESCRIPTION OF THE EMBODIMENTS

The technical solutions in the embodiments of the present invention will be clearly and completely described below in conjunction with the accompanying drawings in the embodiments of the present invention. Apparently, the described embodiments are only a part of the embodiments of the present invention, rather than all the embodiments. Based on the embodiments in the present invention, all other embodiments obtained by those ordinarily skilled in the art without doing creative work shall fall within the protection scope of the present invention.

The present invention provides an in-vehicle virtual soundscape method which is applied to an automobile.

A virtual soundscape is arranged in the automobile. The virtual soundscape is a sound scenario of a target environment created acoustically in the automobile. That is, the virtual soundscape is a sound scenario of the target environment created acoustically for a driver and/or passengers. The target environment includes any one selected from a group consisting of a primitive rainforest environment, a sweetveld environment, a vocal concert environment, and a movie theater environment.

In particular, the automobile is equipped with a multi-channel speaker. The setting of the virtual soundscape is realized in the automobile through the multi-channel speaker.

In particular, the virtual soundscape is realized by the multi-channel speaker that plays a sound in the audio signal; the multi-channel speaker includes a middle channel speaker, a left front channel speaker, a right front channel speaker, a left rear channel speaker, a right rear channel speaker, a left rear surround channel speaker, a right rear surround channel speaker, a sky channel left front speaker, a sky channel right front speaker, a sky channel left rear speaker, and a sky channel right rear speaker;
further, the middle channel speaker is arranged at a center position of a central control instrument panel of the automobile; the left front channel speaker is arranged on a front left door of the automobile; the right front channel speaker is arranged on a front right door of the automobile; the left rear channel speaker is arranged on a rear left door of the automobile; the right rear channel speaker is arranged on a rear right door of the automobile; the left rear surround channel speaker is arranged on a left C-pillar of the automobile; the right rear surround channel speaker is arranged on a right C-pillar of the automobile; and
the sky channel left front speaker is arranged above the left part of the top of a driver seat of the automobile. In this implementation mode, the sky channel left front speaker is arranged above the left part of the head of the driver in the front row in the automobile.

The sky channel right front speaker is arranged above the right part of the top of a front seat of the automobile. In this implementation mode, the sky channel right front speaker is arranged above the right part of the head of a passenger in the front row in the automobile.

The sky channel left rear speaker is arranged above the left part of the top of a rear seat of the automobile. In this implementation mode, the sky channel left rear speaker is arranged above the left part of the head of a passenger in the rear row in the automobile.

The sky channel right rear speaker is arranged above the right part of the top of the rear seat of the automobile. In this implementation mode, the sky channel right rear speaker is arranged above the right part of the head of the passenger in the rear row in the automobile.

Preferably, the sky channel left front speaker, the sky channel right front speaker, the sky channel left rear speaker, and the sky channel right rear speaker are respectively arranged at any one selected from a group consisting of a ceiling position in the automobile, a top position of an A-pillar, a top position of a B-pillar, and a top position of a C-pillar.

Each of the middle channel speaker, the left front channel speaker, the right front channel speaker, the left rear channel speaker, the right rear channel speaker, the left rear surround channel speaker, the right rear surround channel speaker, the sky channel left front speaker, the sky channel right front speaker, the sky channel left rear speaker, and the sky channel right rear speaker is a channel speaker composed of one speaker unit, or a channel speaker composed of a spit frequency system consisting of a plurality of speaker units.

In this implementation mode, each of the middle channel speaker, the left front channel speaker, the right front channel speaker, the left rear channel speaker, the right rear channel speaker, the left rear surround channel speaker, the right rear surround channel speaker, the sky channel left front speaker, the sky channel right front speaker, the sky channel left rear speaker, and the sky channel right rear speaker is a channel speaker composed of a spit frequency system consisting of a plurality of speaker units, such as bass-treble two divided-frequency or bass-mediant-treble three divided-frequency. This setting makes the effect for real representation of the acoustic scenario of the target environment.

By means of disposing the respective channel speakers of the multi-channel speaker at different positions inside the automobile to really represent a necessary hardware environment in the acoustic scenario of the target environment, users can experience auditory perception in the automobile as if they were in the target environment and can get a better sense of presence and immersion, so that the user experience is good.

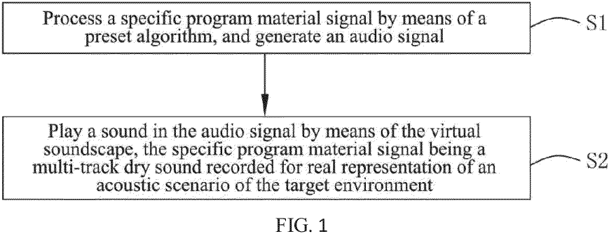

Referring to FIG. 1, FIG. 1 is a flowchart of an in-vehicle virtual soundscape method according to the embodiments of the present invention.

The in-vehicle virtual soundscape method includes the following steps:

S1, a specific program material signal is processed by means of a preset algorithm, and an audio signal is generated.

The preset algorithm is performing convolution processing on the multi-track dry sound and an acoustic impulse response obtained in the target environment.

In particular, the specific program material signal is Siganl_{before}, the acoustic impulse response is H_{Target}, and the audio signal is Signal_{after}, which satisfy the following formula:

Signal_{after}=Siganl_{before} ^{∗}H_{Target}

where * is a convolution operation.

S2, the specific program material signal is processed by means of the preset algorithm, the audio signal is generated, and a sound in the audio signal is played by means of the virtual soundscape.

The specific program material signal is a multi-track dry sound recorded for real representation of an acoustic scenario of the target environment.

The virtual soundscape plays the sound in the audio signal by means of the multi-channel speaker.

Specific descriptions are performed below through the first example:

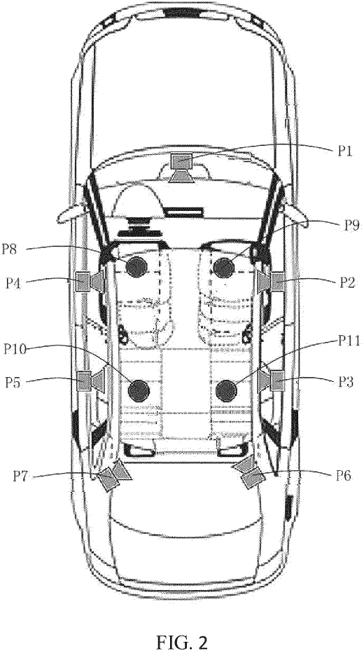

Referring to FIG. 2, FIG. 2 is a schematic diagram of the first example of an in-vehicle virtual soundscape method of the present invention. The middle channel speaker P1 is arranged at the center position of the automobile. The left front channel speaker P4 is arranged on a front left door of the automobile. The right front channel speaker P2 is arranged on a front right door of the automobile. The left rear channel speaker P5 is arranged on a rear left door of the automobile. The right rear channel speaker P3 is arranged on a rear right door of the automobile. The left rear surround channel speaker P7 is arranged on a left C-pillar of the automobile. The right rear surround channel speaker P6 is arranged on a right C-pillar of the automobile.

The sky channel left front speaker P8 is arranged at a left position of a front ceiling of the automobile. The sky channel right front speaker P9 is arranged at a right position of the front ceiling of the automobile. The sky channel right front speaker P10 is arranged at a left position of a rear ceiling of the automobile. The sky channel right front speaker P11 is arranged at a right position of the rear ceiling of the automobile.

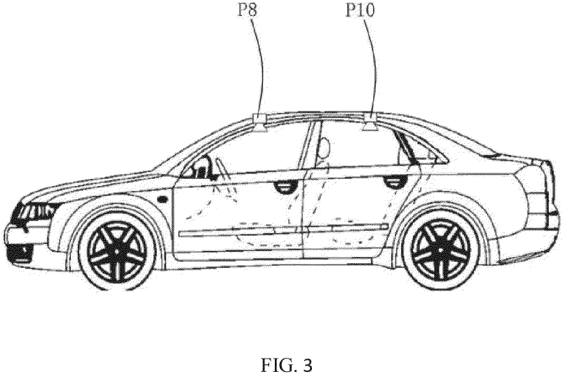

Referring to FIG. 3, FIG. 3 is a schematic diagram of the first example of an in-vehicle virtual soundscape method of the present invention from another view. In the first example, the sky channel left front speaker P8, the sky channel right front speaker P9, the sky channel right front speaker P10, and the sky channel right front speaker P11 are mounted along a radiating direction of the speaker to radiate sounds into the cockpit. Since the position of the ceiling greatly restricts the size and the thickness, the sky channel left front speaker P8, the sky channel right front speaker P9, the sky channel left rear speaker P10, and the sky channel right rear speaker P11 in the first example use ultra-thin rectangular miniature vehicle-mounted speaker, the size of which is 30 × 60 × 17 mm. The middle channel speaker P1, the right front channel speaker P2, the right rear channel speaker P3, the left front channel speaker P4, the left rear channel speaker P5, the right rear surround channel speaker P6, and the left rear surround channel speaker P7 are less restricted in size and all can use a traditional cone-type circular moving-coil speaker.

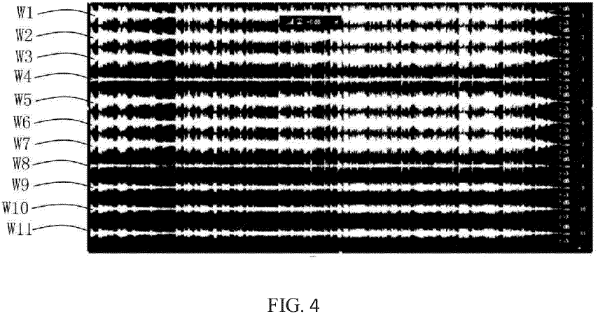

Referring to FIG. 4, FIG. 4 is an oscillograph of a specific program material signal of an in-vehicle virtual soundscape method of the present invention. In the first example, in order to realize a virtual sound scenario for representing a tropical rain forest in the automobile, a dry sound material with 11 tracks is manufactured for in-vehicle playback. The first track W1 is the middle channel, which mainly contains sound elements from the front of the target environment, such as the sound of oncoming wind; the second track W2, the third track W3, the fourth track W4, and the fifth track W5 mainly contains sound elements from a side surface in the target environment, such as disturbance noise of surrounding leaves; the sixth track W6 and the seventh track W7 mainly contain sound elements from the back of the target environment, such as sounds of animals in certain directions; and the eighth track W8, the ninth track W9, the tenth track W10, and the eleventh track W111 mainly contain sound elements from the upper side in the target environment, such as the sound of rain. It should be noted that the specific program materials are not limited to the program materials in the first example, and the content producer can make corresponding production according to different needs. In the above method, the virtual soundscape is arranged in the automobile, and the recorded multi-track dry sound is made into the audio signal, so that the sound in the audio signal is played by means of the virtual soundscape to really represent the acoustic scenario of the target environment. Users can experience auditory perception in the automobile as if they were in the target environment and can get a better sense of presence and immersion, so that the user experience is good.

The present invention further provides an in-vehicle virtual soundscape system 100 which is mounted to an automobile. The in-vehicle virtual soundscape system 100 is configured for being mounted in the automobile to realize a virtual soundscape. The virtual soundscape is a sound scenario of a target environment created acoustically in the automobile.

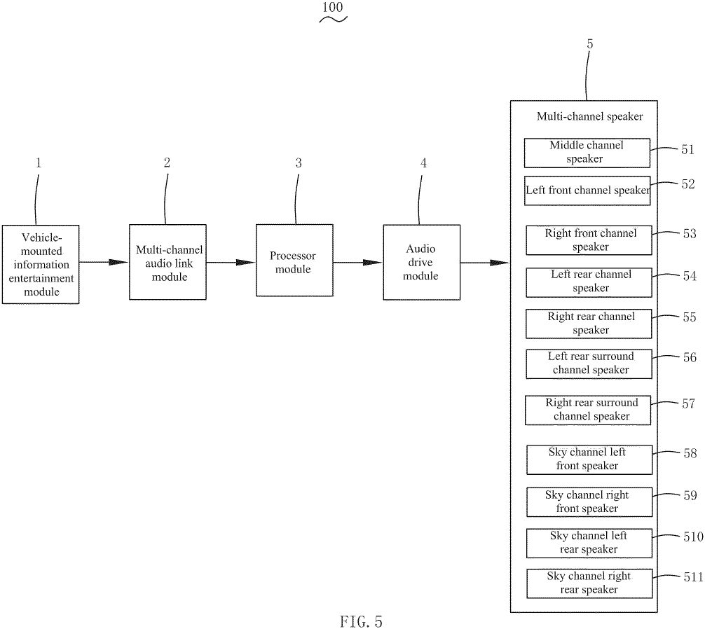

Referring to FIG. 5, it is a structural block diagram of an in-vehicle virtual soundscape system 100 according to the embodiments of the present invention.

In particular, the in-vehicle virtual soundscape system 100 includes a vehicle-mounted information entertainment module 1, a multi-channel audio link module 2, a processor module 3, an audio drive module 4, and a multi-channel speaker 5 which are connected in sequence.

The vehicle-mounted information entertainment module 1 is configured for outputting a specific program material signal in a content to be played. The specific program material signal is a multi-track dry sound recorded for real representation of an acoustic scenario of the target environment.

The multi-channel audio link module 2 is configured for transmitting the specific program material signal. The multi-channel audio link module 2 is a digital signal link or an analog signal link. The digital signal link includes an A2B audio bus and a TDM audio link. The analog signal link includes a copper audio wiring harness and a gold audio wiring harness.

The processor module 3 is configured for processing the received specific program material signal by means of a preset algorithm and generating an audio signal. The preset algorithm is performing convolution processing on the multi-track dry sound and an acoustic impulse response obtained in the target environment. The specific program material signal is Siganl_{before}, the acoustic impulse response is H_{Target}, and the audio signal is Signal_{after}, which satisfy the following formula:

Signal_{after}=Siganl_{before} ^{∗} H_{Target}

where * is a convolution operation.

The acoustic impulse response is pre-stored in the processor module 3.

The audio drive module 4 is configured for performing digital-to-analog conversion on the received audio signal and generating an audio drive signal.

The multi-channel speaker 5 is configured for playing a sound in the received audio drive signal to form the virtual soundscape. The virtual soundscape is a sound scenario of the target environment created acoustically for a driver and/or passengers.

The virtual soundscape plays the sound in the audio signal by means of the multi-channel speaker 5. In particular, the multi-channel speaker 5 includes a middle channel speaker 51, a left front channel speaker 52, a right front channel speaker 53, a left rear channel speaker 54, a right rear channel speaker 55, a left rear surround channel speaker 56, a right rear surround channel speaker 57, a sky channel left front speaker 58, a sky channel right front speaker 59, a sky channel left rear speaker 510, and a sky channel right rear speaker 511.

The middle channel speaker 51 is arranged at a center position of a central control instrument panel of the automobile. The left front channel speaker 52 is arranged on a front left door of the automobile. The right front channel speaker 53 is arranged on a front right door of the automobile. The left rear channel speaker 54 is arranged on a rear left door of the automobile. The right rear channel speaker 55 is arranged on a rear right door of the automobile. The left rear surround channel speaker 56 is arranged on a left C-pillar of the automobile. The right rear surround channel speaker 57 is arranged on a right C-pillar of the automobile. The sky channel left front speaker 58 is arranged above the left part of the top of a driver seat of the automobile. The sky channel right front speaker 59 is arranged above the right part of the top of a front seat of the automobile. The sky channel left rear speaker 510 is arranged above the left part of the top of a rear seat of the automobile. The sky channel right rear speaker 511 is arranged above the right part of the top of the rear seat of the automobile.

The sky channel left front speaker 58, the sky channel right front speaker 59, the sky channel left rear speaker 510, and the sky channel right rear speaker 511 are respectively arranged at any one selected from a group consisting of a ceiling position in the automobile, a top position of an A-pillar, a top position of a B-pillar, and a top position of a C-pillar. The specific positions of the sky channel left front speaker 58, the sky channel right front speaker 59, the sky channel left rear speaker 510, and the sky channel right rear speaker 511 are selected according to an actual design need of an application scenario, and no details will be described here.

Each of the middle channel speaker 51, the left front channel speaker 52, the right front channel speaker 53, the left rear channel speaker 54, the right rear channel speaker 55, the left rear surround channel speaker 56, the right rear surround channel speaker 57, the sky channel left front speaker 58, the sky channel right front speaker 59, the sky channel left rear speaker 510, and the sky channel right rear speaker 511 is a channel speaker composed of one speaker unit, or a channel speaker composed of a spit frequency system consisting of a plurality of speaker units. In the present embodiment, each of the middle channel speaker 51, the left front channel speaker 52, the right front channel speaker 53, the left rear channel speaker 54, the right rear channel speaker 55, the left rear surround channel speaker 56, the right rear surround channel speaker 57, the sky channel left front speaker 58, the sky channel right front speaker 59, the sky channel left rear speaker 510, and the sky channel right rear speaker 511 is a channel speaker composed of a spit frequency system consisting of a plurality of speaker units, such as bass-treble two divided-frequency or bass-mediant-treble three divided-frequency. This setting makes the effect for real representation of the acoustic scenario of the target environment.

In order to optimize an acoustic effect, a power amplifier is further arranged in the in-vehicle virtual soundscape system 100. The power amplifier is configured for performing power amplification on a received electric signal. The power amplifier is arranged in a circuit of the vehicle-mounted information entertainment module 1 or a circuit of the audio drive module 4.

The in-vehicle virtual soundscape system 100 in the automobile realizes the virtual soundscape, and a recorded multi-track dry sound is made into an audio signal, so that the sound in the audio signal is played by means of the in-vehicle virtual soundscape system 100 to really represent the acoustic scenario of the target environment. Users can experience auditory perception in the automobile as if they were in the target environment and can get a better sense of presence and immersion, so that the user experience is good.

It should be pointed out that the vehicle-mounted information entertainment module 1, the multi-channel audio link module 2, the processor module 3, the audio drive module 4, the multi-channel speaker 5, and the power amplifier are all commonly used modules or elements in the art. Their specific performance indexes and types are selected according to an actual design need of an application scenario, and no details are described here.

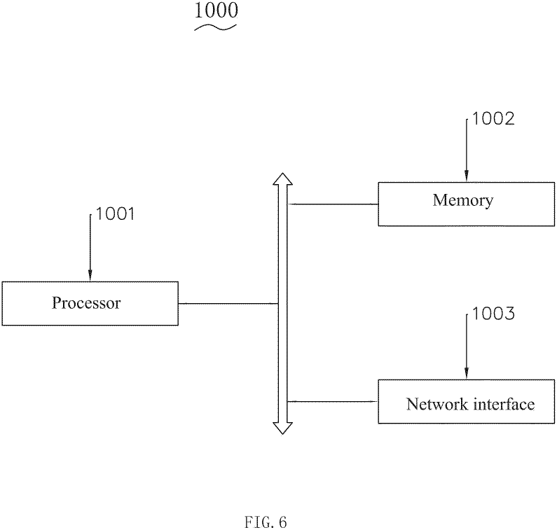

The present invention further provides an in-vehicle virtual soundscape electronic device 1000. Referring to FIG. 6, FIG. 6 is a schematic structural diagram of an in-vehicle virtual soundscape electronic device 1000 of the present invention.

The in-vehicle virtual soundscape electronic device 1000 includes a processor 1001, a memory 1002, a network interface 1003, and a computer program stored on the memory 1002 and capable of being operated on the processor 1001. The processor 1001 is configured for reading a program in the memory 1002. The processor 1001 executes the computer program to implement the steps in the in-vehicle virtual soundscape method provided by the embodiments. That is, the processor 1001 executes the steps in the in-vehicle virtual soundscape method.

In particular, the processor 1001 is configured for executing the following steps:

S1, a specific program material signal is processed by means of a preset algorithm, and an audio signal is generated.

S2, a sound in the audio signal is played by means of the virtual soundscape. The specific program material signal is a multi-track dry sound recorded for real representation of an acoustic scenario of the target environment.

The in-vehicle virtual soundscape electronic device 1000 provided in the embodiments of the present invention can implement the various implementation modes in the in-vehicle virtual soundscape method embodiment and the corresponding beneficial effects. To avoid repetitions, details are omitted here.

It should be pointed out that only the assemblies 1001-1003 are shown in the figure, but it should be understood that it is not required to implement all the illustrated assemblies, and more or fewer assemblies may be implemented instead. Those skilled in the art can understand that the in-vehicle virtual soundscape electronic device 1000 here is a device that can automatically perform numerical value calculation and/or information processing according to pre-set or stored instructions, and its hardware includes, but is not limited to, microprocessors, Application Specific Integrated Circuits (ASICs), Field-Programmable Gate Array (FPGA), Digital Signal Processors (DSPs), embedded devices, etc.

The memory 1002 at least includes one type of readable storage medium. The readable storage medium includes a flash memory, a hard disk, a multimedia card, a card-type memory (for example, an SD or DX memory), a random access memory (RAM), a static random access memory (SRAM), a read-only memory (ROM), an electrically erasable programmable read-only memory (EEPROM), a programmable read-only memory (PROM), a magnetic memory, a magnetic disk, an optical disk, etc. In some embodiments, the memory 1002 may be an internal storage unit of the in-vehicle virtual soundscape electronic device 1000, such as a hard disk or an internal memory of the in-vehicle virtual soundscape electronic device 1000. In some other embodiments, the memory 1002 may also be an external storage device of the in-vehicle virtual soundscape electronic device 1000, such as a plug-in hard disk, a smart media card (SMC), a secure digital (SD) card, a flash card, etc. equipped on the in-vehicle virtual soundscape electronic device 1000. Of course, the memory 1002 may also include both the internal storage unit of the in-vehicle virtual soundscape electronic device 1000 and its external storage device. The memory 1002 stores the computer program that can be executed by the processor 1001. In the present embodiment, the memory 1002 is generally configured for storing operating systems and various application software installed in the in-vehicle virtual soundscape electronic device 1000, such as a program code of the in-vehicle virtual soundscape method of the in-vehicle virtual soundscape electronic device 1000. In addition, the memory 1002 can also be configured for temporarily storing various types of data that have been output or to be output.

The processor 1001 may be a Central Processing Unit (CPU), a controller, a microcontroller, a microprocessor, or other data processing chips in some embodiments. The processor 1001 is generally configured for controlling the overall operation of the in-vehicle virtual sound scene electronic device 1000. In the present embodiment, the processor 1001 is configured for operating the program code stored in the memory 1002 or processing data, for example, operating the program code of the in-vehicle virtual soundscape method of the in-vehicle virtual soundscape electronic device 1000.

The network interface 1003 may include a wireless network interface or a wired network interface. The network interface 1003 is generally configured for establishing a communication connection between the in-vehicle virtual soundscape electronic device 1000 and other electronic devices.

The present specification further provides a computer-readable storage medium that stores a computer program that, when executed by a processor 1001, implements the steps in the in-vehicle virtual soundscape method and can achieve the same technical effects. To avoid repetitions, details are omitted here.

Those of ordinary skill in the art can understand that implementation of all or a part of the processes in the in-vehicle virtual soundscape method of the in-vehicle virtual soundscape electronic device 1000 of the embodiments can be completed by instructing relevant hardware by means of the computer program. The program can be stored in one computer-readable storage medium. When the program is executed, the processes of all the method embodiments can be included. The storage medium may be a magnetic disk, an optical disk, a ROM), a RAM, and the like.

This implementation mode mentioned in the embodiments of the present invention are for convenience of expression. What is disclosed above is only preferred embodiments of the present invention, and of course, is not used to limit the scope of the claims of the present invention. Therefore, equivalent changes made in accordance with the claims of the present invention still fall within the scope of the present invention.

Compared with the related art, the in-vehicle virtual soundscape method, the in-vehicle virtual soundscape system, the in-vehicle virtual soundscape electronic device, and the computer-readable storage medium can all be realized through the steps of the in-vehicle virtual soundscape method. The virtual soundscape is arranged in the automobile and is a sound scenario of the target environment created acoustically in the automobile. In particular, the in-vehicle virtual soundscape method includes the following steps: S1, processing a specific program material signal by means of a preset algorithm, and generating an audio signal; and S2, playing a sound in the audio signal by means of the virtual soundscape, the specific program material signal being a multi-track dry sound recorded for real representation of an acoustic scenario of the target environment. In the above method, the virtual soundscape is arranged in the automobile, and the recorded multi-track dry sound is made into the audio signal, so that the sound in the audio signal is played by means of the virtual soundscape to really represent the acoustic scenario of the target environment. Users can experience auditory perception in the automobile as if they were in the target environment and can get a better sense of presence and immersion, so that the user experience is good.

The above descriptions are only the embodiments of the present invention, and are not intended to limit the scope of the present invention. Any equivalent structure or equivalent process transformation made by using the content of the description and drawings of the present invention and directly or indirectly applied to other related technical fields shall all be similarly included in the scope of patent protection of the present invention.

What is claimed is:

1. An in-vehicle virtual soundscape method applied to an automobile, wherein a virtual soundscape is arranged in the automobile; the virtual soundscape is a sound scenario of a target environment created acoustically in the automobile; the method comprises the following steps:
S1, processing a specific program material signal by means of a preset algorithm, and generating an audio signal; and
S2, playing a sound in the audio signal by means of the virtual soundscape, the specific program material signal being a multi-track dry sound recorded for real representation of an acoustic scenario of the target environment.

2. The in-vehicle virtual soundscape method of claim 1, wherein the automobile is equipped with a multi-channel speaker; the virtual soundscape is realized by the multi-channel speaker that plays a sound in the audio signal; the multi-channel speaker comprises a middle channel speaker, a left front channel speaker, a right front channel speaker, a left rear channel speaker, a right rear channel speaker, a left rear surround channel speaker, a right rear surround channel speaker, a sky channel left front speaker, a sky channel right front speaker, a sky channel left rear speaker, and a sky channel right rear speaker;
wherein the middle channel speaker is arranged at a center position of a central control instrument panel of the automobile; the left front channel speaker is arranged on a front left door of the automobile; the right front channel speaker is arranged on a front right door of the automobile; the left rear channel speaker is arranged on a rear left door of the automobile; the right rear channel speaker is arranged on a rear right door of the automobile; the left rear surround channel speaker is arranged on a left C-pillar of the automobile; the right rear surround channel speaker is arranged on a right C-pillar of the automobile; the sky channel left front speaker is arranged above the left part of the top of a driver seat of the automobile; the sky channel right front speaker is arranged above the right part of the top of a front seat of the automobile; the sky channel left rear speaker is arranged above the left part of the top of a rear seat of the automobile; and the sky channel right rear speaker is arranged above the right part of the top of the rear seat of the automobile.

3. The in-vehicle virtual soundscape method of claim 2, wherein each of the middle channel speaker, the left front channel speaker, the right front channel speaker, the left rear channel speaker, the right rear channel speaker, the left rear surround channel speaker, the right rear surround channel speaker, the sky channel left front speaker, the sky channel right front speaker, the sky channel left rear speaker, and the sky channel right rear speaker is a channel speaker composed of one speaker unit, or a channel speaker composed of a spit frequency system consisting of a plurality of speaker units.

4. The in-vehicle virtual soundscape method of claim 2, wherein the sky channel left front speaker, the sky channel right front speaker, the sky channel left rear speaker, and the sky channel right rear speaker are respectively arranged at any one selected from a group consisting of a ceiling position in the automobile, a top position of an A-pillar, a top position of a B-pillar, and a top position of a C-pillar.

5. The in-vehicle virtual soundscape method of claim 1, wherein in the step S1, the preset algorithm is performing convolution processing on the multi-track dry sound and an acoustic impulse response obtained in the target environment.

6. An in-vehicle virtual soundscape system, wherein the in-vehicle virtual soundscape system is configured for being mounted in an automobile to realize a virtual soundscape; the virtual soundscape is a sound scenario of a target environment created acoustically in the automobile; the in-vehicle virtual soundscape system comprises a vehicle-mounted information entertainment module, a multi-channel audio link module, a processor module, an audio drive module, and a multi-channel speaker which are connected in sequence;
the vehicle-mounted information entertainment module is configured for outputting a specific program material signal in a content to be played, the specific program material signal being a multi-track dry sound recorded for real representation of an acoustic scenario of the target environment;
the multi-channel audio link module is configured for transmitting the specific program material signal;
the processor module is configured for processing the received specific program material signal by means of a preset algorithm, and generating an audio signal; the preset algorithm is performing convolution processing on the multi-track dry sound and an acoustic impulse response obtained in the target environment; the acoustic impulse response is pre-stored in the processor module;
the audio drive module is configured for performing digital-to-analog conversion on the received audio signal and generating an audio drive signal;
the multi-channel speaker is configured for playing a sound in the received audio drive signal to realize the virtual soundscape.

7. The in-vehicle virtual soundscape system of claim 6, wherein the multi-channel audio link module is a digital signal link or analog signal link; the digital signal link comprises an A2B audio bus and a TDM audio link; the analog signal link includes a copper audio wiring harness and a gold audio wiring harness;
a power amplifier is further arranged in the in-vehicle virtual soundscape system; the power amplifier is configured for performing power amplification on a received electric signal; and the power amplifier is arranged in a circuit of the vehicle-mounted information entertainment module or a circuit of the audio drive module.

8. The in-vehicle virtual soundscape system of claim 6, wherein the automobile is equipped with a multi-channel speaker; the virtual soundscape is realized by the multi-channel speaker that plays a sound in the audio signal; the multi-channel speaker comprises a middle channel speaker, a left front channel speaker, a right front channel speaker, a left rear channel speaker, a right rear channel speaker, a left rear surround channel speaker, a right rear surround channel speaker, a sky channel left front speaker, a sky channel right front speaker, a sky channel left rear speaker, and a sky channel right rear speaker;
the middle channel speaker is arranged at a center position of a central control instrument panel of the automobile; the left front channel speaker is arranged on a front left door of the automobile; the right front channel speaker is arranged on a front right door of the automobile; the left rear channel speaker is arranged on a rear left door of the automobile; the right rear channel speaker is arranged on a rear right door of the automobile; the left rear surround channel speaker is arranged on a left C-pillar of the automobile; the right rear surround channel speaker is arranged on a right C-pillar of the automobile; the sky channel left front speaker is arranged above the left part of the top of a driver seat of the automobile; the sky channel right front speaker is arranged above the right part of the top of a front seat of the automobile; the sky channel left rear speaker is arranged above the left part of the top of a rear seat of the automobile; the sky channel right rear speaker is arranged above the right part of the top of the rear seat of the automobile;
the sky channel left front speaker, the sky channel right front speaker, the sky channel left rear speaker, and the sky channel right rear speaker are respectively arranged at any one selected from a group consisting of a ceiling position in the automobile, a top position of an A-pillar, a top position of a B-pillar, and a top position of a C-pillar;
each of the middle channel speaker, the left front channel speaker, the right front channel speaker, the left rear channel speaker, the right rear channel speaker, the left rear surround channel speaker, the right rear surround channel speaker, the sky channel left front speaker, the sky channel right front speaker, the sky channel left rear speaker, and the sky channel right rear speaker is a channel speaker composed of one speaker unit, or a channel speaker composed of a spit frequency system consisting of a plurality of speaker units.

9. An in-vehicle virtual soundscape electronic device, wherein the in-vehicle virtual soundscape electronic device comprises a processor and a memory; the memory stores a computer program capable of being executed by the processor; the processor reads a program in the memory to implement the steps in the in-vehicle virtual soundscape method of claim 1.
